(19) United States
(12) Patent Application Publication
(10) Pub. No.: US 2024/0338560 A1
(43) Pub. Date: Oct. 10, 2024

(54) SYSTEMS AND METHODS FOR GESTURE GENERATION FROM TEXT AND NON-SPEECH

(71) Applicant: Datum Point Labs Inc., Jackson, WY (US)

(72) Inventors: Gwantae Kim, Seoul (KR); Hanseok Ko, Seoul (KR)

(21) Appl. No.: 18/626,959

(22) Filed: Apr. 4, 2024

Related U.S. Application Data
(60) Provisional application No. 63/457,561, filed on Apr. 6, 2023.

(51) Int. Cl. G06N 3/08; G06N 3/0455

(52) U.S. Cl. CPC G06N 3/08; G06N 3/0455

(57) ABSTRACT

Embodiments described herein provide systems and methods for gesture generation from multimodal input. A method includes receiving a multimodal input. The method may further include masking a subset of the multimodal input; generating, via an embedder, a multimodal embedding based on the masked multimodal input; generating, via an encoder, multimodal features based on the multimodal embedding, wherein the encoder includes one or more attention layers connecting different modalities; generating, via a generator, multimodal output based on the multimodal features; computing a loss based on the multimodal input and the multimodal output. The method may further include updating parameters of the encoder based on the loss.

### CROSS REFERENCE(S)

The instant application is a nonprovisional of and claim priority under 35 U.S.C. 119 to U.S. provisional application No. 63/457,561, filed Apr. 6, 2023, which is hereby expressly incorporated by reference herein in its entirety.

### TECHNICAL FIELD

The embodiments relate generally to systems and methods for gesture generation from text, speech, and/or other modalities.

### BACKGROUND

When virtual agents interact with humans, gestures are crucial to delivering their intentions with speech. Previous multimodal co-speech gesture generation models required encoded features of all modalities to generate gestures. If some input modalities are removed or contain noise, the model may not generate the gestures properly. Therefore, there is a need for improved systems and methods for gesture generation from text and non-speech.

### BRIEF DESCRIPTION OF THE DRAWINGS

FIGS. 1A-1B illustrate a framework for gesture generation, according to some embodiments.

FIG. 2A illustrates additional model details of an embedder and generator, according to some embodiments.

FIG. 2B illustrates additional model details of an encoder and decoder, according to some embodiments.

FIG. 3 illustrates an exemplary visualization of generated gestures, according to some embodiments.

FIG. 4 is a simplified diagram illustrating a computing device implementing the framework described herein, according to some embodiments.

FIG. 5 is a simplified diagram illustrating a neural network structure, according to some embodiments.

FIG. 6 is a simplified block diagram of a networked system suitable for implementing the framework described herein, according to some embodiments.

FIG. 7A-7C are exemplary logic flow diagrams, according to some embodiments.

FIGS. 8A-8B are exemplary devices with digital avatar interfaces, according to some embodiments.

FIGS. 9-10 provide charts illustrating exemplary performance of different embodiments described herein.

### DETAILED DESCRIPTION

Virtual agents are being deployed to various fields such as the video industry, service industry, news, and social network services. In order to create a human-like behavior, the current virtual agent is played by a real person or uses pre-generated speech and gestures. Instead, to create a more realistic, automatic virtual human, research in various fields such as character design, speech understanding/synthesis, natural language understanding/generation, and gesture is required. Embodiments herein include systems and methods for gesture generation from text and non-speech. Embodiments described herein may generate full-body gestures that occur with text and speech, known as Co-speech gesture generation. Such Co-speech gestures are a representative example of nonverbal communication between people. When gestures are mixed, a much more natural conversation becomes possible in the human-human interaction process compared to standing still during speaking.

Rules-based approaches require a huge amount of data to generate gestures in general scenarios. Existing alternative methods fail to generate the gestures when some parts of the input modalities are corrupted. Therefore, the problem of generalizability remains.

One of the main challenges of co-speech gesture generation studies is determining how to select and encode speech and other modalities. Previous deep learning models designed encoders for every modality and merge their information with concatenation or Recurrent Neural Networks (RNNs). However, since the weights of the input modalities are all the same if using these methods, the generator could refer to unusable information when some input modalities are missing or noisy. Embodiments described herein solve this problem. Embodiments include a multi-head self-attention encoder. The proposed encoder module can attend only useful information with attention weights.

Another main obstacle of co-speech gesture generation studies is body model and visualization. Existing Co-speech gesture datasets and methods often use the upper-body or 3D joint position. However, full-body representation with 3D joint rotation is necessary for real applications, such as virtual agents and social robots. Moreover, lower body movements, such as the movement of the center of gravity, increase naturalness. Therefore, embodiments described herein use a 3D joint rotation-based full-body model to represent gestures.

Embodiments herein include a co-speech gesture generation model that uses the text and speech modality. The model may be trained in three stages. First, an embedding and generating model may be trained for joint embedding space between pose, text, and speech (stage 1). Next, a Multimodal Pretrained Encoder for Gesture generation (MPE4G) is trained with the self-supervised learning (stage 2). Finally, an end-to-end fine-tuning method for gesture generation (stage 3).

Embodiments described herein provide a number of benefits. For example, the fully-connected embedder initially reduces the domain gap between different modalities with joint embedding loss (stage 1). Further, the pre-trained multi-head self-attention-based encoder generates integrated hidden representations with self-supervised learning (stage 2). Thanks to the properties of the self-attention mechanism that focuses on important features, more rich hidden representations can be acquired. The decoder with multi-head self-attention layers, instead of RNN layers. In contrast to RNNs, frames of the Transformer layers can refer to all other frames, as well as focus on important frames, and therefore the transformer can generate motions robustly.

As used herein, “multimodal,” “multimodality,” and similar words may refer to one or more modalities. By way of non-limiting example, multimodal may indicate one or more of speech, text, or pose.

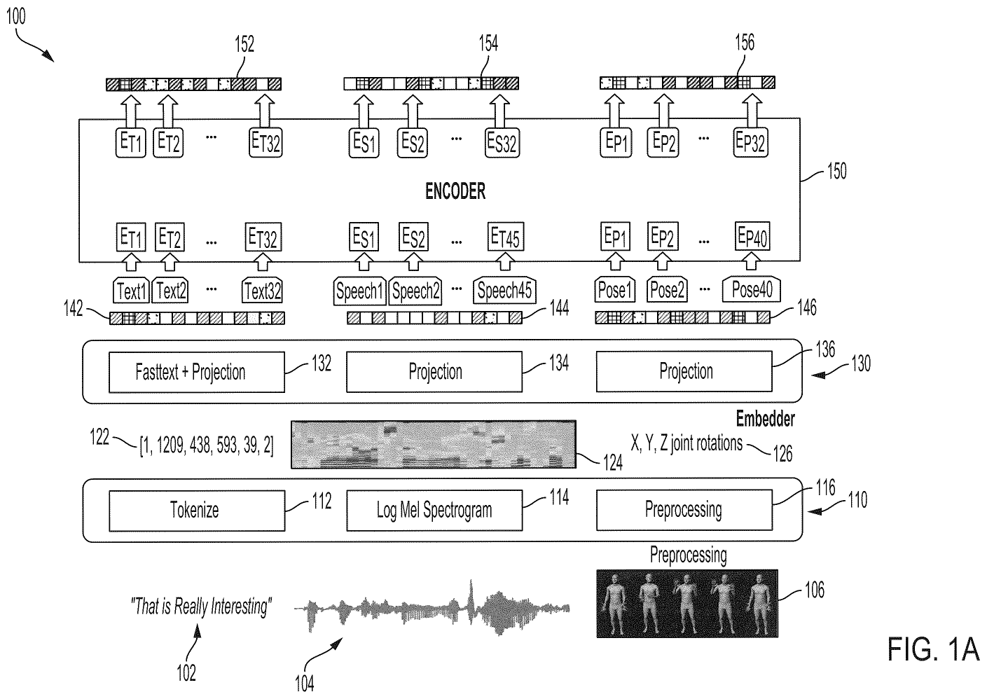

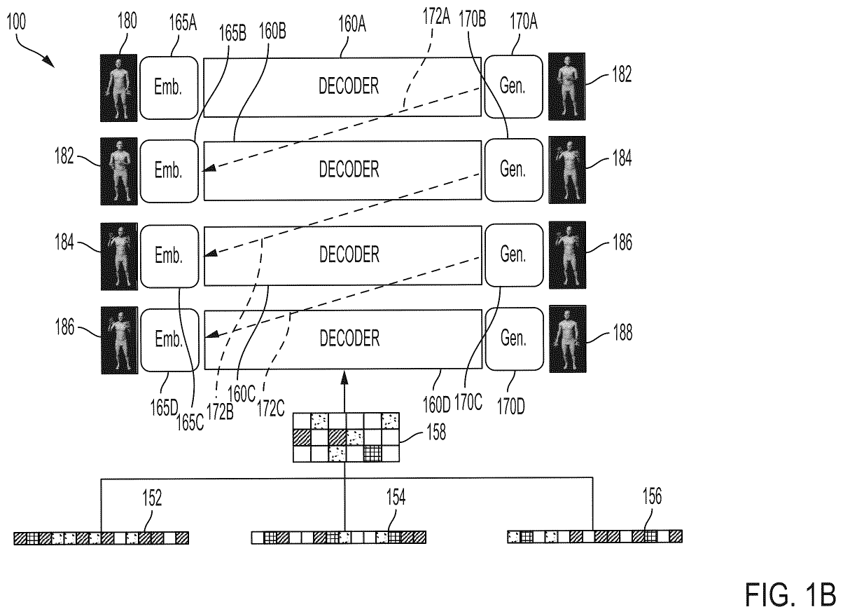

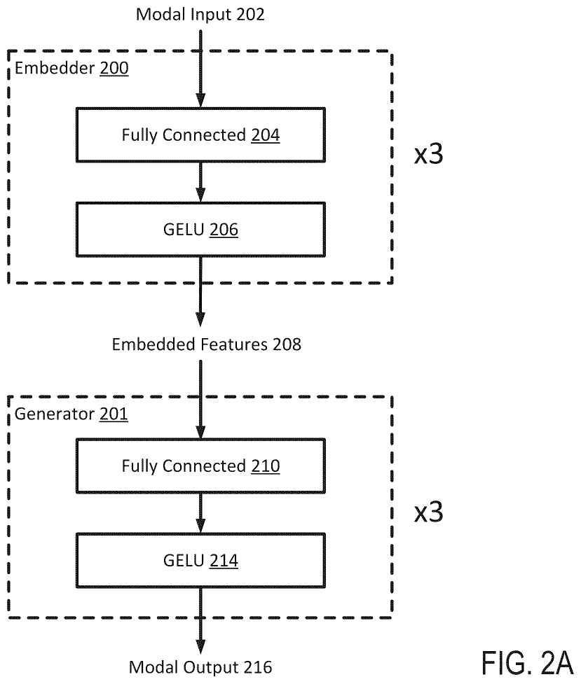

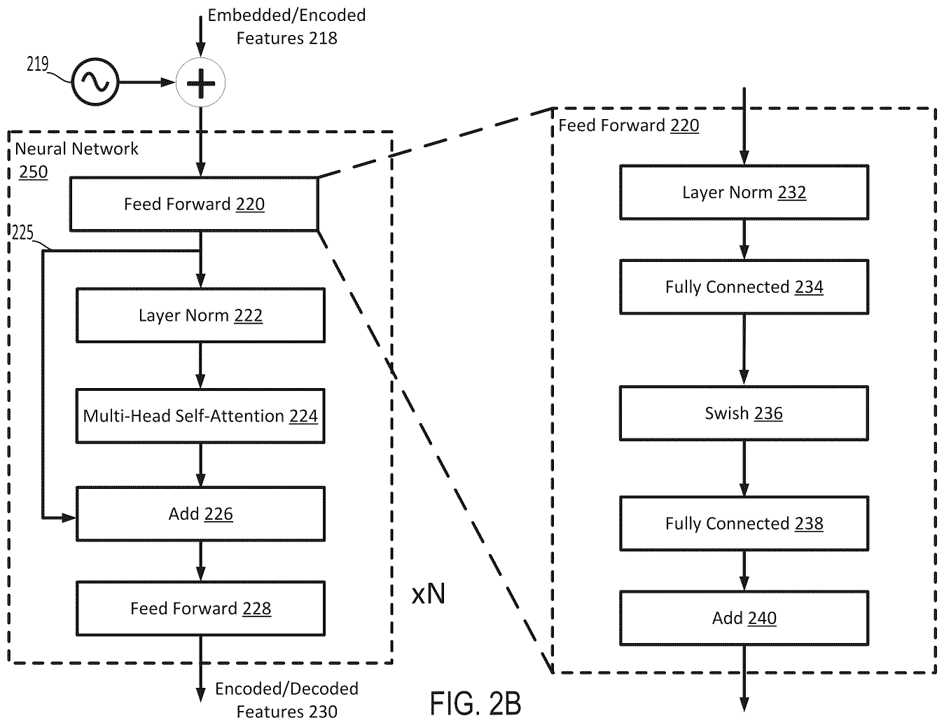

FIGS. 1A-1B illustrate a framework 100 for gesture generation, according to some embodiments. Framework 100 may receive multiple different modalities of input data, e.g., text, speech, and poses. Text may be in the of words in a phrase of sentence. Speech may be an audio file or clip of someone speaking. Poses may be a motion sequence comprised by a sequence of frames. Framework 100 includes preprocessor 110, embedder 130, encoder 150, decoders 160A-D, embedders 165A-D, and generators 170A-D. The network architecture of various components in framework 100 is described in FIGS. 2A and 2B.

Framework 100 may receive input in the form of text 102, speech 104, and pose 106. As depicted in FIG. 1A, the text 102 may be a phrase, “This is Really Interesting,” the speech 104 may be an audio file with a particular waveform, and the pose 106 may be a sequence of poses/body configurations/motions, which when displayed at a sufficiently high frame rate would depict continuous movement of a body. In some embodiments, input may be time-aligned and cropped to 1.33 seconds. The text 102, speech 104, and pose 106 may be received by a preprocessor 110.

Preprocessor 110 may include a separate preprocessor for each different input modality, e.g., a text preprocessor 112, a speech preprocessor 114, and/or a pose preprocessor 116. Preprocessor may generate processed multimodal input from multimodal input. Text preprocessor 112 may generate processed text input 122 from text 102. Speech preprocessor 114 may generate processed speech input 124 from speech 104. Pose preprocessor 116 may generate processed pose input 126 from pose 106.

In some embodiments, the text preprocessor 112 may tokenize the input text using a word-level dictionary. Tokenized input text may be zero-padded to a pre-defined length. In some embodiments, the speech preprocessor 114 may generate a log-Mel spectrogram with Fourier transform parameters [nfft, win_length, hop_length, n_mels]=[2048, 60 ms, 30 ms, 128]. In some embodiments, the pose preprocessor 116 may generate a pose vector comprising normalized 3D joint rotation angles in radians. The shapes of the preprocessed features are text t=[b, l_{T}], speech s=[b, l_{S}, 128], and pose p=[b, l_{P}, 165], where b denotes a batch size and l_{T}, l_{S}, and l_{P} denote feature lengths for each of the modalities: text, speech, and pose. In some embodiments l_{T}, l_{S}, and l_{P} are set to 32, 45, 40. Other batch sizes, feature lengths, and data preprocessing formats may be used. Examples given above are non-limiting. The processed multimodal inputs, which may be referred to simply as multimodal inputs, may be received at an embedder 130.

Embedder 130 may include a separate embedder for each modality, e.g., a text embedder 132, a speech embedder 134, and/or a pose embedder 136. Embedder 130 may generate multimodal embeddings from (processed) multimodal input. Multimodal embeddings may be in a feature space, where the feature space is the target space of the embedder 130. Text embedder 132 may generate text embeddings 142 from input text 122. In some embodiments, text embedder 132 may include a Fasttext embedder and a projection network comprising three fully-connected layers. Fasttext is described in Yoon et al., Robots learn social skills: End-to-end learning of co-speech gesture generation for humanoid robots, 2019 International Conference on Robotics and Automation (ICRA). IEEE, 2019, pp. 4303-4309. Speech embedder 134 may generate speech embeddings 144 from input speech 124. In some embodiments, speech embedder 134 may include a projection network comprising three fully-connected layers. Pose embedder 136 may generate pose embeddings 146 from input pose 126. In some embodiments, pose embedder 136 may include a projection network comprising three fully-connected layers. The structure of the projection networks of embedders 132, 134, 136 is further described in FIG. 2A. In some embodiments, the embeddings for each modality, i.e., text embeddings 142, speech embeddings 144, and pose embeddings 146, may be concatenated and then received at an encoder 150.

Encoder 150 may generate multimodal features from multimodal embeddings. In some embodiments, multimodal features 158 are in the same feature space as the multimodal embeddings. For example, in training stage 2 as described herein, the multimodal features 158 consist of text, speech and pose (e.g., 40 pose tokens) features. For example, in the training stage 3 and inference stage as described herein, the multimodal features contain text, speech, and previous pose output (e.g., 10 pose tokens, and the left 30 pose tokens are zero) features. Multimodal features 158 may include text features 152, speech features 154, and/or pose features 156. In some embodiments, encoder 150 may have attention layers which may include two feed-forward layers and one multi-head self-attention layer with residual connections. The network architecture of the encoder is further described in FIG. 2B. In some embodiments, the text features 152, speech features 154, and pose features 156 may be concatenated to form multimodal features 158. Multimodal features 158 may be received at decoders 160A-D.

Decoders 160A-D may be a single decoder used iteratively to generate a sequence of poses based on multimodal features 158 and earlier poses in a pose/motion sequence. As depicted in FIG. 1B, the decoders 160A-D generate four poses 182, 184, 186, 188. Pose embedder 165A generates a starting pose embedding from the starting pose 180. Decoder 160A generates first pose features based on the starting pose embedding and multimodal features 158. A pose generator 170A may generate a first pose 182 from the first pose features. First pose 182 may be received (see arrow 172A) by pose embedder 165B. Pose embedder 165B generates first pose embeddings based on the first pose 182. First pose embeddings may be received by decoder 160B. Decoder 160B generates second pose features based on the first pose features and multimodal features 158. A pose generator 170B may generate a second pose 184 from the second pose features. Second pose 184 may be received (see arrow 172B) by pose embedder 165C. Pose embedder 165C generates second pose embeddings based on the second pose 182. Second pose embeddings may be received by decoder 160C. Decoder 160C may generate third pose features based on the second pose features and multimodal features 158. A pose generator 170C may generate a third pose 186 from the third pose features. Third pose 186 may be received (see arrow 172C) by pose embedder 165D. Pose embedder 165D generates third pose embeddings based on the third pose 184. Third pose embeddings may be received by decoder 160D. Decoder 160D may generate fourth pose features based on the third pose features and multimodal features 158. A pose generator 170D may generate a fourth pose 188. Generation of additional poses in a sequence may continue for a pre-defined number of iterations or until a stop condition is met.

Pose generators 170A-D may generate pose output in the same space as processed pose input 126 based on pose embeddings 146 or pose features 156. Pose generators 170A-D may be a single pose generator applied multiple times during pose sequence generation. Similar generators are defined for other modalities, e.g., a text generator and/or a speech generator. A text generator may generate text output in the same space as processed text input 122 based on text embeddings 142 or text features 152. A speech generator may generate speech output in the same space as processed speech input 124 based on speech embeddings 144 or speech features 154. In some embodiments, pose generators, text generators, and speech generators comprise three fully-connected layers. The structure of generators is further described in FIG. 2A.

Training of framework 100 may be performed over multiple stages. In some embodiments, a first training stage trains an embedder 130 and generator (e.g., pose generator 170A-D and text and speech generator described herein) with a joint embedding space between pose, text, and/or speech. In some embodiments, a second stage trains a multimodal encoder 150 via self-supervised learning. In some embodiments, a third stage trains end-to-end the gesture generation model.

In the first stage, a frame-wise embedder 130 and generator may be trained with joint embedding loss and reconstruction loss. In some embodiments, the processed text input 122 are projected using Fasttext word embedding and additional 3 fully-connected layers as shown in FIG. 2A. The preprocessed speech input 124 and pose input 126 may be projected using 3 fully-connected layers. In some embodiments, the generator consists of 3 fully-connected layers for each modality, and its role is to reconstruct outputs from embedded features.

Text embedding 142, speech embedding 144, and pose embedding 146 may be denoted E_{T}, E_{S}, and E_{P}, respectively. A joint embedding loss may be calculated by text-speech and text-pose alignment, without zero-padded text. The text-speech joint embedding loss may be defined:

$${ℒ}_{{J}_{S}} = {\sum }_{{N}_{t} = 1}^{{l}_{T}} \vert {E}_{{T}_{{N}_{t}}} - \frac{1}{{l}_{ST}} {\sum }_{{N}_{s} = {l}_{ST} {N}_{t}}^{{l}_{ST} ( {N}_{t} + 1 )} {E}_{{S}_{{N}_{s}}} \vert \qquad ( 1 )$$

where I_{ST}=l_{S}/l_{T}. An IT is the non-zero-padded text length, i.e., not 32 in stage 1. Similarly, the text-pose joint embedding loss may be defined:

$${ℒ}_{{J}_{P}} = {\sum }_{{N}_{t} = 1}^{{l}_{T}} \vert {E}_{{T}_{{N}_{t}}} - \frac{1}{{l}_{PT}} {\sum }_{{N}_{p} = {l}_{PT} {N}_{t}}^{{l}_{PT} ( {N}_{t} + 1 )} {E}_{{P}_{{N}_{p}}} \vert \qquad ( 2 )$$

where l_{PT}=l_{P}/l_{T}. The L1 distance between text embedding, speech embedding, and pose embedding at the same timestamps may be decreased while minimized the embedding losses in Eqs. (1) and (2). A reconstruction loss may be calculated with cross-entropy loss and L1 distance:

$${ℒ}_{recon} = {ℒ}_{CE} ( t , \hat{t} ) + \vert s - \hat{s} \vert + \vert p - \hat{p} \vert . \qquad ( 3 )$$

where \hat{t} is generated from the text embedding 142, E_{T}, by the text generator, ŝ is generated from the speech embedding 144, E_{S}, and \hat{p} is generated from the pose embedding 146, E_{P}.

In some embodiments, the parameters of the text embedder 132, speech embedder 134, pose embedder 136, text generator, speech generator, and pose generator may be updated with a loss L=0.01 (L_{JS}+L_{JP})+L_{recon}, Adam optimizer, learning rate 0.005, batch size 64, and 50 epochs. Other combinations of the losses in Eqs. 1-3, and fewer or more losses, may be used to update the parameters of the embedders and generators.

In a second stage of training, a multimodal encoder 150 may be trained with self-supervised learning. The input feature of the multimodal encoder 150 may be the concatenation of the text, speech, and pose embeddings 142, 144, 146. In some embodiments, the multimodal encoder 150 may include N=4 attention layers that comprise of two feed-forward layers and one multi-head self-attention layer with residual connections. Sinusoidal positional encoding may be added at the beginning of the encoder 150. Self-supervised learning methods may be used to train encoder 150. Various kinds of masking of the input may be used. For example, the input text 122 may be fully ignored with 10% probability, one word may be masked with 72% probability, one word may be changed to a random word with 9% probability, or no masking may be done with 9% probability. For example, the input speech may be fully ignored with 10% probability, 5 continuous frames may be masked with 72% probability, 5 continuous frames may be changed to random values with 9% probability, or no masking may be done with 9% probability. For example, the input pose may be fully ignored with 10% probability, 5 continuous frames may be masked with 9% probability, 5 continuous frames may be changed to random values with 9% probability, the last 30 frames may be masked for the next frame prediction with 63%, or no masking may be done with 9% probability. Other forms of masking and different selections for the probabilities of each kind of masking are encompassed by the present disclosure. The multimodal encoder may reconstruct texts, speeches, and poses using masked inputs with reconstruction loss (3). The masked inputs may pass through an embedder 132, 134, 136, encoder 150, and generator in that order to estimate the reconstructed outputs, e.g., reconstructed speech, text, or pose. The encoder model can learn relations and joint-embedded space for texts, speeches, and poses. In some embodiments, the parameters of an encoder 150 may be optimized/updated with reconstruction loss L=L_{recon}, e.g., Eq. 3, Adam optimizer, learning rate 0.005, batch size 64, and 100 epochs. In some embodiments, the parameters of the embedder and generator may be frozen in the second training stage.

In the third stage, an embedder 132, 134, 136, encoder 150, decoder 160A-D, and generator may be jointly trained with supervised learning. A decoder model may comprise an N=1 multi-head attention block, which is shown in FIG. 2B and described below, but with multi-head self-attention 224 replaced with multi-head attention. The decoder may generate each frame/pose with an auto-regressive method in training and testing. In some embodiments, when the decoder generates the n-th pose feature, the query of the multi-head attention may be previous generated poses, and the key and value of the multi-head attention are all output features of the encoder, i.e., multimodal features 158. In some embodiments, to preserve the consistency of the poses, 10 previous poses, which are outputs of previous iterations of the decoder may be used as the query. When n<10, the input of the model may be picked from pre-poses, instead of generated frames. In some embodiments, pre-poses are standard poses (e.g., mean pose of all data). In the beginning of pose generation, there are no previous gesture frames/poses. Thus, in that case (n<10), the pre-poses may be utilized.

In some embodiments, a reconstruction loss of the text and speech, as used in stage 2, may also be used in stage 3 to update the parameters of the embedder, encoder, decoder, and generator. A reconstruction loss may help preserve information on each modality in the encoder outputs. Further, in some embodiments, a pose loss, which contains L1 reconstruction loss, motion velocity loss, and motion variance loss, may be used to update the parameters of the embedder, encoder, decoder, and generator. The pose loss may be modified to maximize motion velocity loss, instead of minimizing it, to generate more active movements. In some embodiments, the embedder, encoder, decoder, and generator may be trained with reconstruction loss, pose loss, Adam optimizer, learning rate 0.005, batch size 32, and 360 epochs. Other losses and training parameters are encompassed by the present disclosure.

FIG. 2A illustrates additional model details of an embedder 200 and generator 201, according to some embodiments. Embedder 200 may have three fully-connected layers 204 with GELU activation 206. Embedder 200 receives modal input 202 (e.g., processed text input 122, processed speech input 124, or processed pose input 126) and generates embedded features 208 (e.g., text embeddings 142, speech embeddings 144, or pose embeddings 146). Text embedder 132, speech embedder 134, and pose embedder 136 may have similar structure to embedder 200.

Generator 201 may have three fully-connected layers 210 with GELU activation 214. Generator 201 receives embedded features 208 (e.g., text embeddings 142, speech embeddings 144, pose embeddings 146, text features 152, speech features 154, or pose features 156) and generates modal output (e.g., ŝ, \hat{t}, or \hat{p} as described herein). Pose generators 170A-D may have similar structure to generator 201.

FIG. 2B illustrates additional model details of an encoder 150 and decoder 160A-D, according to some embodiments. Neural network 250 includes a feed forward block 220, layer normalization 222, multi-head self-attention 224, residual connection 225, add 226, and a feed forward block 228. Feed forward block 220 may include layer normalization 232, a fully-connected layer 234, a swish function 236, a fully connected layer 238, and add 240. In some embodiments, neural network 250 may receive embedded/encoded features 218 (e.g., text embeddings 142, speech embeddings 144, and pose embeddings 146) with added sinusoidal positional encoding 219. In some embodiments, neural network 250 generates encoded/decoded features 230. A larger network may be constructed from N copies of neural network 250.

In some embodiments, encoder 150 may comprise the structure of neural network 250 with N=4. When neural network 250 is used in the encoder 150, the embedded/encoded features 218 may be text embedding 142, speech embedding 144, and/or pose embedding 146 and the encoded/decoded features 230 may be text features 152, speech features 154, and/or pose features 156 (or collectively multimodal features 158).

In some embodiments, decoder 160A-D may comprise the structure of neural network 250 with N=1 and multi-head attention 224 instead of self-attention. When neural network 250 is used in the decoder 160A-D, the embedded/encoded features 218 may include multimodal features 158 and the encoded/decoded features 230 may be pose features as described herein.

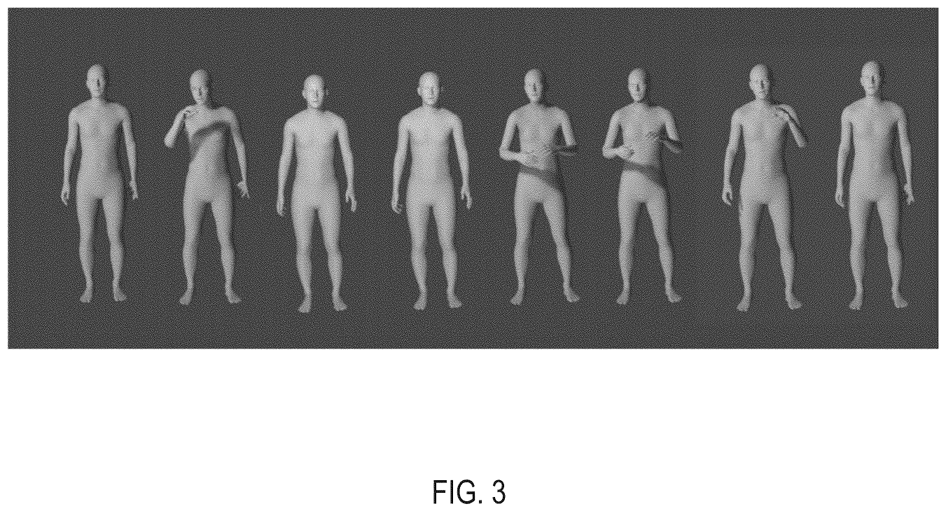

FIG. 3 illustrates an exemplary visualization of generated gestures, according to some embodiments. As illustrated, realistic gestures may be generated using framework 100. Gestures generated via framework 100 may be visualized as illustrated in FIG. 3. In some embodiments, texture maps may be applied to a 3D mesh generated according to the generated gesture to present a virtual avatar.

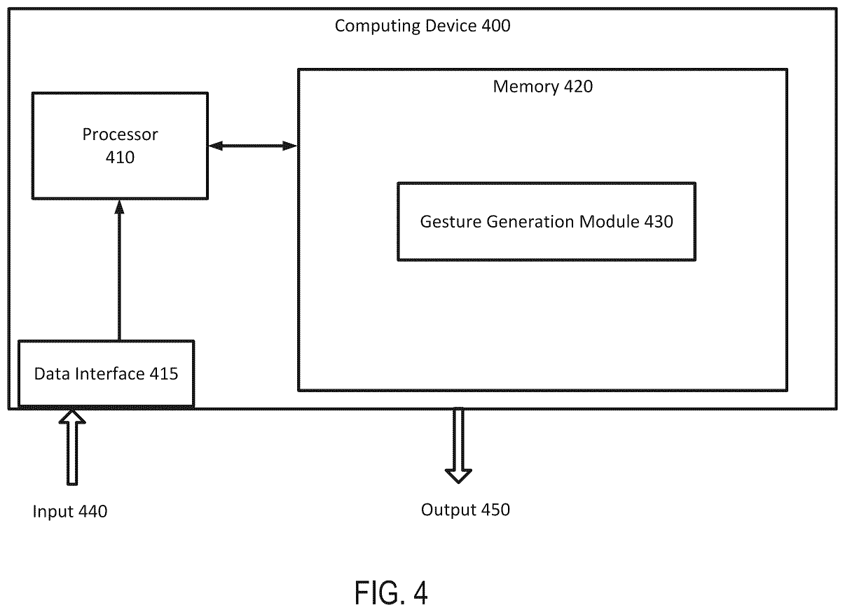

FIG. 4 is a simplified diagram illustrating a computing device 400 implementing the framework described herein, according to some embodiments. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of transitory or non-transitory machine-readable media (e.g., computer-readable media). Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for gesture generation module 430 that may be used to implement and/or emulate the systems and models, and/or to implement any of the methods described further herein.

Gesture generation module 430 may receive input 440 such as input text, audio, or pose vectors, training data, model parameters, etc. and generate an output 450 such as a generated gesture and/or a rendered virtual avatar based on a generated gesture. For example, gesture generation module 430 may be configured to generate gestures and/or train a gesture generation model as described herein.

The data interface 415 may comprise a communication interface, a user interface (such as a voice input interface, a graphical user interface, and/or the like). For example, the computing device 400 may receive the input 440 from a networked device via a communication interface. Or the computing device 400 may receive the input 440, such as text, audio, and/or pose vectors, from a user via the user interface.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

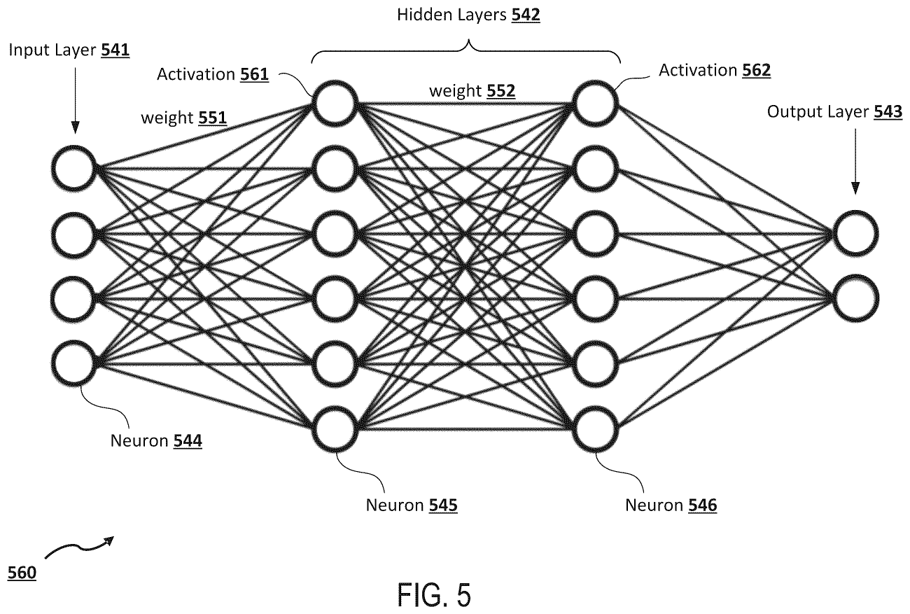

FIG. 5 is a simplified diagram illustrating the neural network structure, according to some embodiments. In some embodiments, the gesture generation module 430 may be implemented at least partially via an artificial neural network structure shown in FIG. 5. The neural network comprises a computing system that is built on a collection of connected units or nodes, referred to as neurons (e.g., 544, 545, 546). Neurons are often connected by edges, and an adjustable weight (e.g., 551, 552) is often associated with the edge. The neurons are often aggregated into layers such that different layers may perform different transformations on the respective input and output transformed input data onto the next layer.

For example, the neural network architecture may comprise an input layer 541, one or more hidden layers 542 and an output layer 543. Each layer may comprise a plurality of neurons, and neurons between layers are interconnected according to a specific topology of the neural network topology. The input layer 541 receives the input data such as training data, user input data, vectors representing latent features, etc. The number of nodes (neurons) in the input layer 541 may be determined by the dimensionality of the input data (e.g., the length of a vector of the input). Each node in the input layer represents a feature or attribute of the input.

The hidden layers 542 are intermediate layers between the input and output layers of a neural network. It is noted that two hidden layers 542 are shown in FIG. 5 for illustrative purpose only, and any number of hidden layers may be utilized in a neural network structure. Hidden layers 542 may extract and transform the input data through a series of weighted computations and activation functions.

For example, as discussed in FIG. 4, the gesture generation module 430 receives an input 440 and transforms the input into an output 450. To perform the transformation, a neural network such as the one illustrated in FIG. 5 may be utilized to perform, at least in part, the transformation. Each neuron receives input signals, performs a weighted sum of the inputs according to weights assigned to each connection (e.g., 551, 552), and then applies an activation function (e.g., 561, 562, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 541 is transformed into rather different values indicative data characteristics corresponding to a task that the neural network structure has been designed to perform.

The output layer 543 is the final layer of the neural network structure. It produces the network's output or prediction based on the computations performed in the preceding layers (e.g., 541, 542). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the gesture generation module 430 may comprise the transformative neural network structure of layers of neurons, and weights and activation functions describing the non-linear transformation at each neuron. Such a neural network structure is often implemented on one or more hardware processors 410, such as a graphics processing unit (GPU).

In one embodiment, the gesture generation module 430 may be implemented by hardware, software and/or a combination thereof. For example, the gesture generation module 430 may comprise a specific neural network structure implemented and run on various hardware platforms 560, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 560 used to implement the neural network structure is specifically configured based on factors such as the complexity of the neural network, the scale of the tasks (e.g., training time, input data scale, size of training dataset, etc.), and the desired performance.

In one embodiment, the neural network based gesture generation module 430 may be trained by iteratively updating the underlying parameters (e.g., weights 551, 552, etc., bias parameters and/or coefficients in the activation functions 561, 562 associated with neurons) of the neural network based on a loss function. For example, during forward propagation, the training data such as aligned text, speech, and pose are fed into the neural network. The data flows through the network's layers 541, 542, with each layer performing computations based on its weights, biases, and activation functions until the output layer 543 produces the network's output 550. In some embodiments, output layer 543 produces an intermediate output on which the network's output 550 is based.

The output generated by the output layer 543 is compared to the expected output (e.g., a “ground-truth” such as the corresponding pose/motion sequence) from the training data, to compute a loss function that measures the discrepancy between the predicted output and the expected output. Given a loss function, the negative gradient of the loss function is computed with respect to each weight of each layer individually. Such negative gradient is computed one layer at a time, iteratively backward from the last layer 543 to the input layer 541 of the neural network. These gradients quantify the sensitivity of the network's output to changes in the parameters. The chain rule of calculus is applied to efficiently calculate these gradients by propagating the gradients backward from the output layer 543 to the input layer 541.

Parameters of the neural network are updated backwardly from the last layer to the input layer (backpropagating) based on the computed negative gradient using an optimization algorithm to minimize the loss. The backpropagation from the last layer 543 to the input layer 541 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as gesture generation on unseen text, audio, and/or pose vectors, including noisy or sparse inputs.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

The neural network illustrated in FIG. 5 is exemplary. For example, different neural network structures may be utilized, and additional neural-network based or non-neural-network based component may be used in conjunction as part of module 430. For example, a text input may first be embedded by an embedding model, a self-attention layer, etc. into a feature vector. The feature vector may be used as the input to input layer 541. Output from output layer 543 may be output directly to a user or may undergo further processing. For example, the output from output layer 543 may be decoded by a neural network based decoder. The neural network illustrated in FIG. 500 and described herein is representative and demonstrates a physical implementation for performing the methods described herein.

Through the training process, the neural network is “updated” into a trained neural network with updated parameters such as weights and biases. The trained neural network may be used in inference to perform the tasks described herein, for example those performed by module 430. The trained neural network thus improves neural network technology in gesture generation.

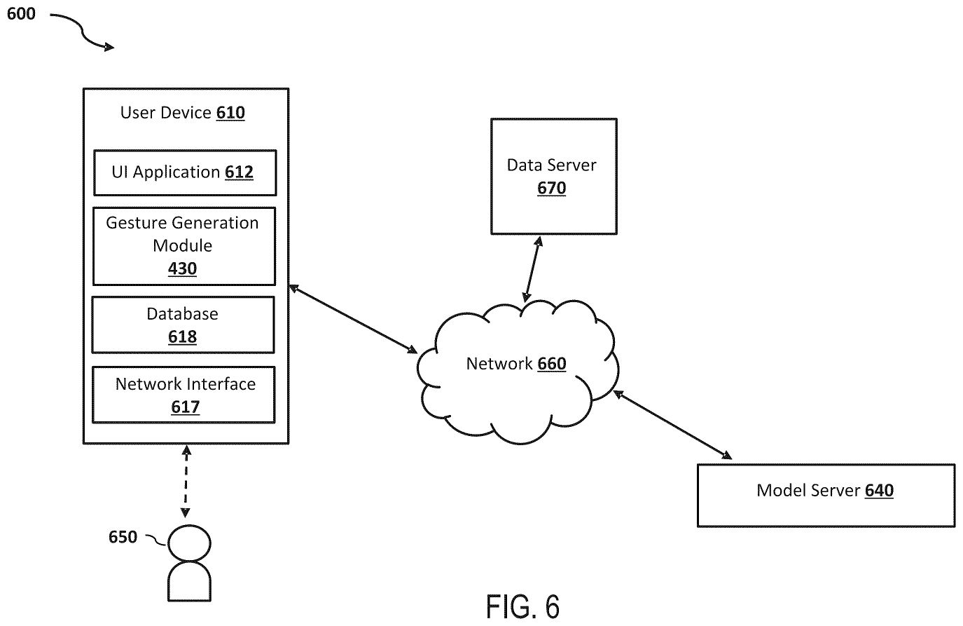

FIG. 6 is a simplified block diagram of a networked system 600 suitable for implementing the framework described herein. In one embodiment, system 600 includes the user device 610 (e.g., computing device 400) which may be operated by user 650, data server 670, model server 640, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4, operating an OS such as a MICROSOFT® OS, a UNIX® OS, a LINUX® OS, a real-time operation system (RTOS), or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities. In some embodiments, user device 610 is used in training neural network based models. In some embodiments, user device 610 is used in performing inference tasks using pre-trained neural network based models (locally or on a model server such as model server 640).

User device 610, data server 670, and model server 640 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660. User device 610, data server 670, and/or model server 640 may be a computing device 400 (or similar) as described herein.

In some embodiments, all or a subset of the actions described herein may be performed solely by user device 610. In some embodiments, all or a subset of the actions described herein may be performed in a distributed fashion by various network devices, for example as described herein.

User device 610 may be implemented as a communication device that may utilize appropriate hardware and software configured for wired and/or wireless communication with data server 670 and/or the model server 640. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and gesture generation module 430, which may correspond to executable processes, procedures, and/or applications with associated hardware. For example, the user device 610 may allow a user to generate gestures. In other embodiments, user device 610 may include additional or different modules having specialized hardware and/or software as required.

In various embodiments, user device 610 includes other applications as may be desired in particular embodiments to provide features to user device 610. For example, other applications may include security applications for implementing client-side security features, programmatic client applications for interfacing with appropriate application programming interfaces (APIs) over network 660, or other types of applications. Other applications may also include communication applications, such as email, texting, voice, social networking, and IM applications that allow a user to send and receive emails, calls, texts, and other notifications through network 660.

Network 660 may be a network which is internal to an organization, such that information may be contained within secure boundaries. In some embodiments, network 660 may be a wide area network such as the internet. In some embodiments, network 660 may be comprised of direct physical connections between the devices. In some embodiments, network 660 may represent communication between different portions of a single device (e.g., a communication bus on a motherboard of a computation device).

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

User device 610 may further include database 618 stored in a transitory and/or non-transitory memory of user device 610, which may store various applications and data (e.g., model parameters) and be utilized during execution of various modules of user device 610. Database 618 may store text, audio, pose vectors, generated gestures, model parameters, texture maps, etc. In some embodiments, database 618 may be local to user device 610. However, in other embodiments, database 618 may be external to user device 610 and accessible by user device 610, including cloud storage systems and/or databases that are accessible over network 660 (e.g., on data server 670).

User device 610 may include at least one network interface component 617 adapted to communicate with data server 670 and/or model server 640. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data Server 670 may perform some of the functions described herein. For example, data server 670 may store a training dataset including aligned text, speech, and pose, etc. Data server 670 may provide data to user device 610 and/or model server 640. For example, training data may be stored on data server 670 and that training data may be retrieved by model server 640 while training a model stored on model server 640.

Model server 640 may be a server that hosts models described herein. Model server 640 may provide an interface via network 660 such that user device 610 may perform functions relating to the models as described herein (e.g., gesture generation). Model server 640 may communicate outputs of the models to user device 610 via network 660. User device 610 may display model outputs, or information based on model outputs, via a user interface to user 650.

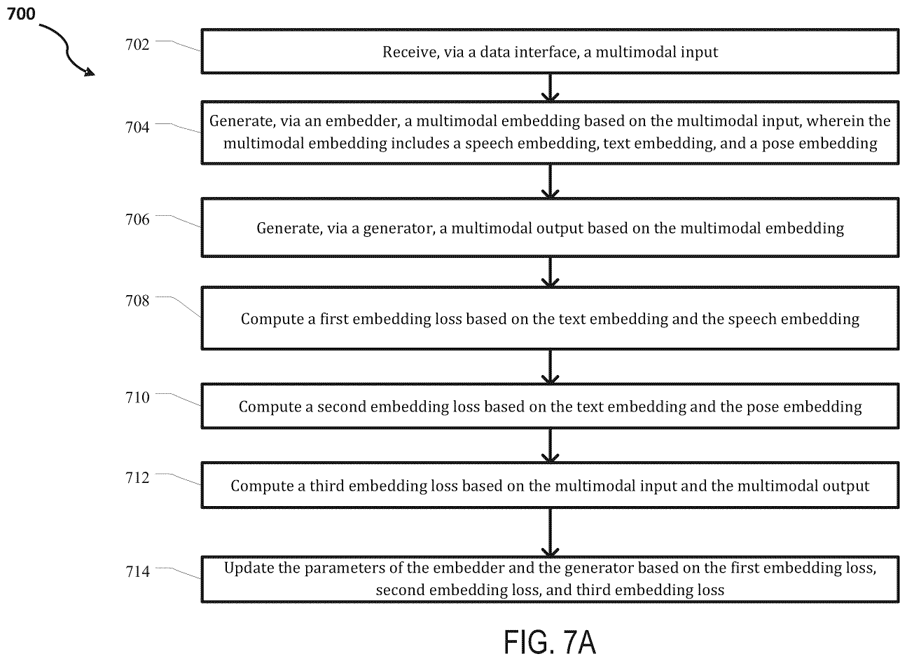

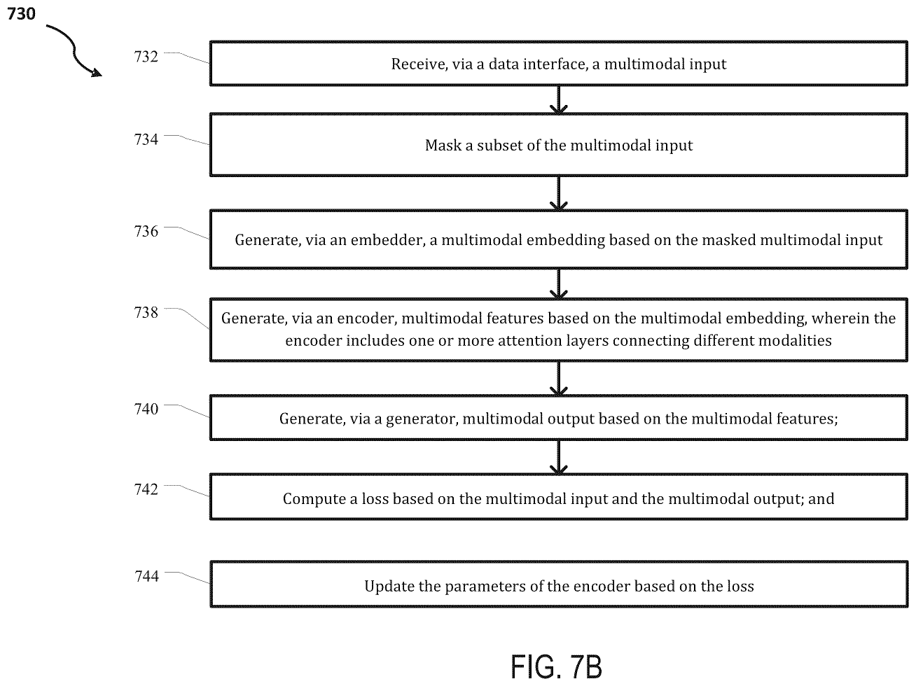

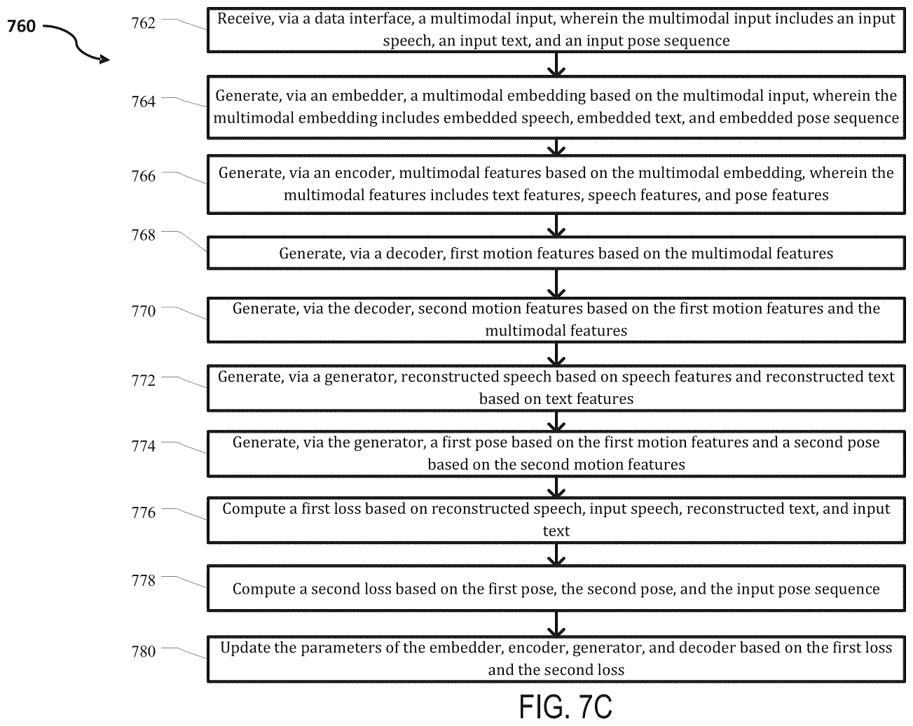

FIGS. 7A-7C are example logic flow diagrams, according to some embodiments described herein. One or more of the processes of FIGS. 7A-7C may be implemented, at least in part, in the form of executable code stored on non-transitory, tangible, machine-readable media that when run by one or more processors may cause the one or more processors to perform one or more of the processes (e.g., computing device 400). In some embodiments, methods 700, 730, and 760 correspond to the operation of the gesture generation module 430 that performs training and/or inference of a gesture generation model.

As illustrated, the methods 700, 730, and 760 include a number of enumerated steps, but aspects of the methods 700, 730, and 760 may include additional steps before, after, and in between the enumerated steps. In some aspects, one or more of the enumerated steps may be omitted or performed in a different order. Further, methods 700, 730, and 760 may be used together in any combination. For example, training may be performed in three stages with each of methods 700, 730, and 760 representing a different stage of training.

FIG. 7A illustrates a method 700 for training an embedder (e.g., text embedder 132, speech embedder 134, pose embedder 136, and/or embedder 200) and a generator (e.g., generator 201 or 170A-D).

At step 702, a system (e.g., computing device 400, user device 610, model server 640, device 800, or device 815) receives, via a data interface (e.g., data interface 415, network interface 617), a multimodal input (e.g., text 102, speech 104, and/or pose sequence 106).

At step 704, the system generates, via an embedder (e.g., embedder 130), a multimodal embedding based on the multimodal input, wherein the multimodal embedding includes a speech embedding (e.g., speech embedding 144), text embedding (e.g., text embedding 142), and a pose embedding (e.g., pose embedding 146). In some embodiments, the embedder includes a text embedder, speech embedder, and pose embedder, wherein the text embedder generates a text embedding in the multimodal embedding based on the text input, the speech embedder generates a speech embedding in the multimodal embedding based on the speech input, and the pose embedder generates a pose embedding in the multimodal embedding based on the pose input. In some embodiments, the generating the multimodal embedding includes first processing an intermediate representation based on the multimodal input (e.g., pre-processing 110). In some embodiments, the embedder is a neural network comprising at least one fully-connected layer.

At step 706, the system generates, via a generator (e.g., generator 201), a multimodal output (e.g., a predicted reconstruction of the multimodal input) based on the multimodal embedding.

At step 708, the system computes a first embedding loss based on the text embedding and the speech embedding (e.g., text-speech alignment loss described in equation (1)).

At step 710, the system computes a second embedding loss based on the text embedding and the pose embedding (e.g., text-pose alignment loss described in equation (2)).

At step 712, the system computes a third embedding loss based on the multimodal input and the multimodal output (e.g., reconstruction loss described in equation (3)).

At step 714, the system updates the parameters of the embedder and the generator based on the first embedding loss, second embedding loss, and third embedding loss.

FIG. 7B illustrates a method 730 for training an encoder (e.g., encoder 150).

At step 732, a system (e.g., computing device 400, user device 610, model server 640, device 800, or device 815) receives, via a data interface (e.g., data interface 415, network interface 617), a multimodal input (e.g., text 102, speech 104, and/or pose sequence 106).

At step 734, the system masks a subset of the multimodal input. In some embodiments, masking the multimodal input comprises at least one of: removing all text input based on a first probability; removing a first subset of the text input based on a second probability; replacing a second subset of the text input with random words based on a third probability; removing all speech input based on a fourth probability; removing a first subset of the speech input based on a fifth probability; replacing a second subset of the speech input with random speech based on a sixth probability; removing all pose input based on a seventh probability; removing a first subset of the pose input based on an eighth probability; or replacing a second subset of the pose input with random poses based on a ninth probability.

At step 736, the system generates, via an embedder (e.g., embedder 130), a multimodal embedding (e.g., speech embedding 144, text embedding 142, and pose embedding 146) based on the masked multimodal input. In some embodiments, the embedder includes a text embedder, speech embedder, and pose embedder, wherein the text embedder generates a text embedding in the multimodal embedding based on the text input, the speech embedder generates a speech embedding in the multimodal embedding based on the speech input, and the pose embedder generates a pose embedding in the multimodal embedding based on the pose input. In some embodiments, the generating the multimodal embedding includes first processing an intermediate representation based on the multimodal input (e.g., pre-processing 110). In some embodiments, the embedder is a neural network comprising at least one fully-connected layer.

At step 738, the system generates, via an encoder (e.g., encoder 150), multimodal features (e.g., features 142, 144, and 146) based on the multimodal embedding, wherein the encoder includes one or more attention layers connecting different modalities.

At step 740, the system generates, via a generator (e.g., generator 201), multimodal output based on the multimodal features.

At step 742, the system computes a loss based on the multimodal input and the multimodal output (e.g., reconstruction loss described in equation (3)).

At step 744, the system updates parameters of the encoder based on the loss.

FIG. 7C illustrates a method 760 for training a multimodality input to gesture generator model (e.g., the model of framework 100).

At step 762, a system (e.g., computing device 400, user device 610, model server 640, device 800, or device 815) receives, via a data interface (e.g., data interface 415, network interface 617), a multimodal input, wherein the multimodal input includes an input speech (e.g., speech 104), an input text (e.g., text 102), and an input pose sequence (e.g., pose sequence 106).

At step 764, the system generates, via an embedder (e.g., embedder 130 or embedder 200), a multimodal embedding based on the multimodal input, wherein the multimodal embedding includes embedded speech (e.g., speech embedding 144), embedded text (e.g., text embedding 142), and embedded pose sequence (e.g., pose embedding 146). In some embodiments, the embedder includes a text embedder, speech embedder, and pose embedder, wherein the text embedder generates a text embedding in the multimodal embedding based on the text input, the speech embedder generates a speech embedding in the multimodal embedding based on the speech input, and the pose embedder generates a pose embedding in the multimodal embedding based on the pose input. In some embodiments, the generating the multimodal embedding includes first processing an intermediate representation based on the multimodal input (e.g., pre-processing 110). In some embodiments, the embedder is a neural network comprising at least one fully-connected layer.

At step 766, the system generates, via an encoder (e.g., encoder 150), multimodal features based on the multimodal embedding, wherein the multimodal features include text features (e.g., text features 142), speech features (e.g., speech features 144), and pose features (e.g., pose features 146). In some embodiments, the encoder includes one or more attention layers connecting different modalities.

At step 768, the system generates, via a decoder (e.g., decoder 160), first motion features based on the multimodal features. In some embodiments, the decoder includes one or more attention layers, wherein a query associated with one or more attention layers is based on the first pose and a key and value associated with one or more attention layers are based on the multimodal features.

At step 770, the system generates, via the decoder, second motion features based on the first motion features and the multimodal features.

At step 772, the system generates, via a generator (e.g., generator 201), reconstructed speech based on speech features and reconstructed text based on text features.

At step 774, the system generates, via the generator, a first pose based on the first motion features and a second pose based on the second motion features.

At step 776, the system computes a first loss based on reconstructed speech, input speech, reconstructed text, and input text (e.g., as described in equation 3 without the last term depending on the poses, p and \hat{p}).

At step 778, the system computes a second loss based on the first pose, the second pose, and the input pose sequence (e.g., the pose loss as described herein).

At step 780, the system updates parameters of the embedder, encoder, generator, and decoder based on the first loss and the second loss.

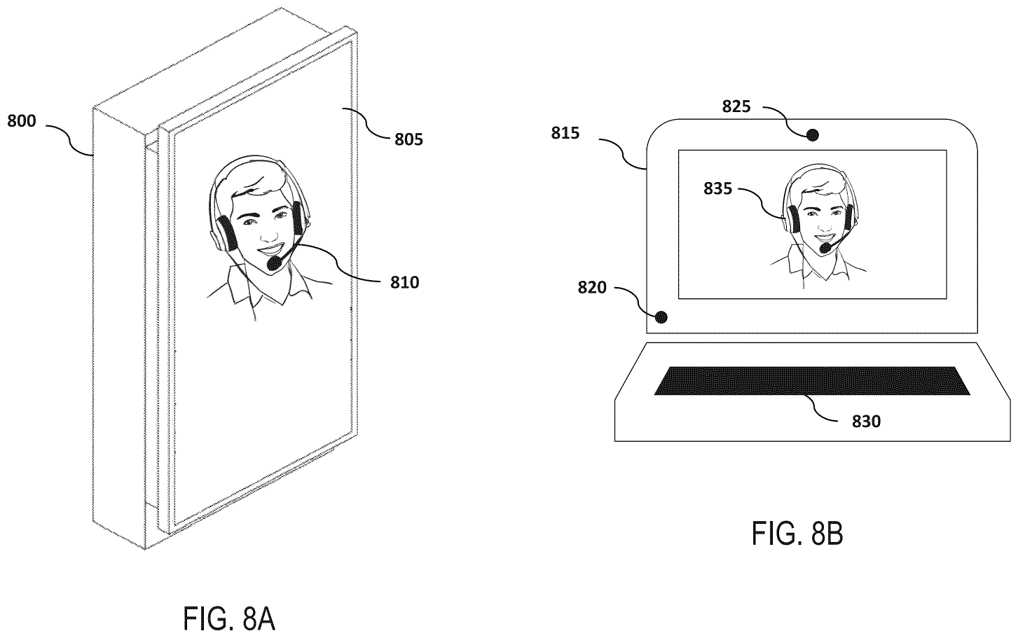

FIG. 8A is an exemplary device 800 with a digital avatar interface, according to some embodiments. Device 800 may be, for example, a kiosk that is available for use at a store, a library, a transit station, etc. Device 800 may display a digital avatar 810 on display 805. In some embodiments, a user may interact with the digital avatar 810 as they would a person, using voice and non-verbal gestures. Digital avatar 810 may interact with a user via digitally synthesized gestures, digitally synthesized voice, etc. Gestures of virtual avatar 810 may be generated according to embodiments described herein. For example, a gesture may be generated according to a provided or generated text and/or audio, and the digital avatar 810 may visualize the generated gesture together with the text/audio so that it appears digital avatar is naturally speaking the text/audio. In some embodiments, the text and/or audio is generated via a neural network based model. In some embodiments, the text and/or audio is input by a user whose appearance is replaced by digital avatar 810.

Device 800 may include one or more microphones, and one or more image-capture devices (not shown) for user interaction. Device 800 may be connected to a network (e.g., network 660). Digital Avatar 810 may be controlled via local software and/or through software that is at a central server accessed via a network. For example, an AI model may be used to control the behavior of digital avatar 810, and that AI model may be run remotely. In some embodiments, device 800 may be configured to perform functions described herein (e.g., via digital avatar 810). For example, device 800 may perform one or more of the functions as described with reference to computing device 400 or user device 610. For example, gesture generation.

FIG. 8B is an exemplary device 815 with a digital avatar interface, according to some embodiments. Device 815 may be, for example, a personal laptop computer or other computing device. Device 815 may have an application that displays a digital avatar 835 with functionality similar to device 800. For example, device 815 may include a microphone 820 and image capturing device 825, which may be used to interact with digital avatar 835. In addition, device 815 may have other input devices such as a keyboard 830 for entering text.

Digital avatar 835 may interact with a user via digitally synthesized gestures, digitally synthesized voice, etc. Gestures of virtual avatar 835 may be generated according to embodiments described herein. For example, a gesture may be generated according to a provided or generated text and/or audio, and the digital avatar 835 may visualize the generated gesture together with the text/audio so that it appears digital avatar is naturally speaking the text/audio. In some embodiments, the text and/or audio is generated via a neural network based model. In some embodiments, the text and/or audio is input by a user whose appearance is replaced by digital avatar 835.

In some embodiments, device 815 may be configured to perform functions described herein (e.g., via digital avatar 835). For example, device 815 may perform one or more of the functions as described with reference to computing device 400 or user device 610. For example, gesture generation.

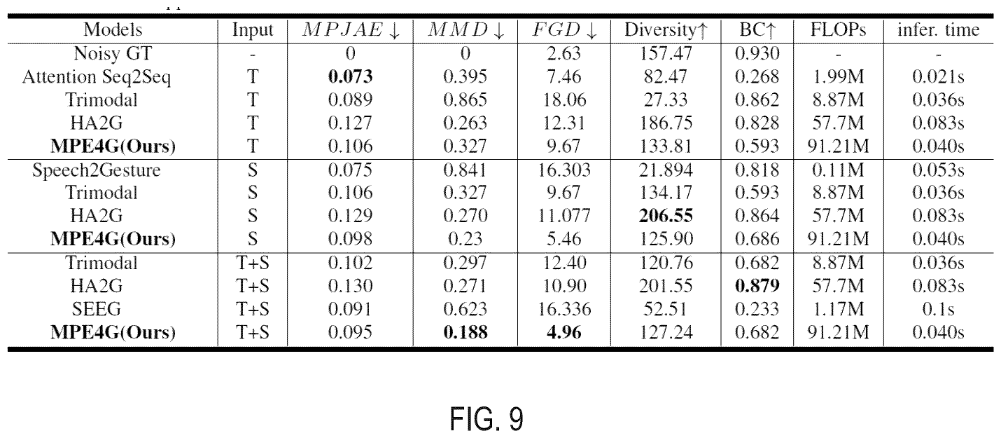

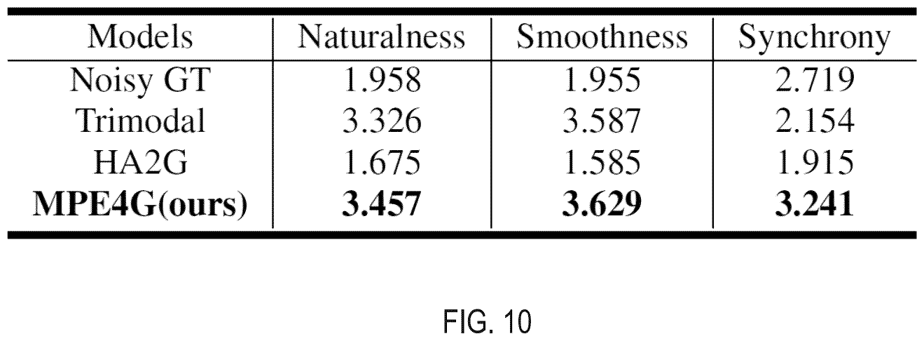

FIGS. 9-10 provide charts illustrating exemplary performance of different embodiments described herein. The dataset utilized in experiments is a modified GENEA-EXPOSE, a modification GENEA challenge 2022 dataset, the GENEA challenge 2022 dataset is described in Yoon et al., The GENEA Challenge 2022: A large evaluation of data-driven co-speech gesture generation, Proceedings of the ACM International Conference on Multimodal Interaction, 2022. Baseline models utilized in the experiments include Attention Seq2Seq as described in Yoon et al., Robots learn social skills: End-to-end learning of co-speech gesture generation for humanoid robots, International Conference on Robotics and Automation (ICRA), IEEE, pp. 4303-4309, 2019; Trimodal as described in Yoon et al., Speech gesture generation from the trimodal context of text, audio, and speaker identity, ACM Transaction on Graphics (TOG), vol. 39, no. 6, pp. 1-16, 2020; HA2G as described in Liu et al., Learning hierarchical cross-modal association for co-speech gesture generation, Proceedings of the CVPR, pp. 10462-10472, 2022; Speech2Gesture as described in Ginosar et al., Learning individual styles of conversational gesture, Computer Vision and Pattern Recognition (CVPR), 2019; and SEEG as described in Liang et al., SEEG: Semantic energized co-speech gesture generation, Proceedings of the IEEE/CVF Conference on Computer Vision and Pattern Recognition, 2022. Embodiments of the methods described herein are indicated in the charts as “MPE4G”.

The GENEA-EXPOSE dataset is a modification of the GENEA Challenge 2022 dataset. The motion data format, bvh, of GENEA Challenge 2022 is converted to the SMPL-X body model. Videos are generated by applying the challenge visualization toolkit to motion data and using Expose to each video frame-by-frame. Expose is described in Choutas et al., Monocular expressive body regression through body-driven attention, in European Conference on Computer Vision (ECCV), 2020, pp. 20-40. Frame-wise Expose results are merged and used as Co-speech gesture data. Since the timestamps of each frame are the same as the video, aligned text and speech files may be used easily. Finally, aligned full-body gestures are collected, which contain not only upper body joints but also hand and lower body joints, audio, and text samples.

Metrics used in the charts include mean per joint angle error (MPJAE) as described in Ionescu et al., Human3. 6m: Large scale datasets and predictive methods for 3d human sensing in natural environments, IEEE transactions on pattern analysis and machine intelligence, vol. 36, no. 7, pp. 1325-1339, 2013. MPHAE is used to measure the difference between ground truth pose and generated pose. Since the data structure contains 3D joint angles, the MPJAE can be simply implemented with mean absolute error. Another metric used is maximum mean discrepancy (MMD) which measures the similarity between two distributions. It is used to measure the quality of generated samples compared with ground truth. MMD has also been shown to be consistent with human evaluation. Another metric used is Fréchet Gesture Distance (FGD), a kind of inception-score measurement. FGD measures how close the distribution of generated gestures is to the ground truth gestures. FGD is calculated as the Fréchet distance between the latent representations of real gestures and generated gestures. Another metric used is beat consistency score (BC), a metric for motion-audio beat correlation, used in dance generation. BC was used to observe the consistency between audio and generated pose. Another metric used is a diversity measure of how well the model can generate variate motions. An FGD auto-encoder use used to get latent feature vectors of the generated gestures and calculate the average feature distance. The number of synthesized gesture pairs is 500, which is randomly selected from the test set.

FIG. 9 illustrates quantitative results on the GENEA-EXPOSE dataset. Input T is text and input S is speech. The up arrow denotes that higher score is better and down arrow indicates that lower score is better. The attention Seq2Seq model with text inputs has good MPJAE and FGD scores, but other scores are bad. These results mean the model sometimes generates ground-truth-like gestures, but it cannot generate natural gestures. Trimodal and HA2G, and MPE4G (ours) used both speech and text modality. The MPE4G framework described herein outperforms baselines and state-of-the-art models in MMD and FGD, which measure distribution similarity. In detail, MMD and FGD determine the overall generation performance of the generative models because they compare overall distributions between GT and generated samples, not sample by sample. MPE4G did not have the best score on MPJAE, Diversity, and BC scores. However, the balance between these scores is more important than each individual score. MPJAE compares joint angles of ground truth and generated samples for every test sample. Therefore, low MPJAE means the generated sample is exactly the same as the ground truth. However, not only the exactness but also the diversity of the generative models are important. Since MPJAE cannot measure the diversity of the generated samples, experiments measured Diversity and BC. One may expect high Diversity and low BC. However, if the generated motions are meaningless but have high variation, the Diversity goes high (high Diversity but unwanted results). Moreover, BC focuses on beat consistency with the speech signal. If there is motion in the part where there is an audio signal, the BC comes out high. If the meaningless motions are repeated whether speech exists or not, BC goes high (low BC but unwanted results). Therefore, low MPJAE, high Diversity, and low BC must happen at once. As illustrated, MPE4G has the best-balanced scores on MPJAE, Diversity, and BC. Moreover, the baseline models produce worse results when some input modalities are missing, but the model described herein can preserve generation performance in the same case.

FIG. 10 illustrates qualitative results on the GENEA-EXPOSE dataset. Experiments used the Mean Opinion Score (MOS) about naturalness, smoothness, and synchrony. A higher score denotes better results. The method described herein (MPE4G) outperforms baseline methods. Especially, the generated gestures using MPE4G achieve better results compared to noisy ground truth although the models trained by the noisy ground truth. Therefore, the method described herein promises better results when training data is corrupted.

The devices described above may be implemented by one or more hardware components, software components, and/or a combination of the hardware components and the software components. For example, the device and the components described in the exemplary embodiments may be implemented, for example, using one or more general purpose computers or special purpose computers such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and one or more software applications which are performed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of the processing element. For example, the processing device may include a plurality of processors or include one processor and one controller. Further, another processing configuration such as a parallel processor may be implemented.

The software may include a computer program, a code, an instruction, or a combination of one or more of them, which configure the processing device to be operated as desired or independently or collectively command the processing device. The software and/or data may be interpreted by a processing device or embodied in any tangible machines, components, physical devices, computer storage media, or devices to provide an instruction or data to the processing device. The software may be distributed on a computer system connected through a network to be stored or executed in a distributed manner The software and data may be stored in one or more computer readable recording media.

The method according to the exemplary embodiment may be implemented as a program instruction which may be executed by various computers to be recorded in a computer readable medium. At this time, the medium may continuously store a computer executable program or temporarily store it to execute or download the program. Further, the medium may be various recording means or storage means to which a single or a plurality of hardware is coupled and the medium is not limited to a medium which is directly connected to any computer system, but may be distributed on the network. Examples of the medium may include magnetic media such as hard disk, floppy disks and magnetic tapes, optical media such as CD-ROMs and DVDs, magneto-optical media such as optical disks, and ROMs, RAMS, and flash memories to be specifically configured to store program instructions. Further, an example of another medium may include a recording medium or a storage medium which is managed by an app store which distributes application, a site and servers which supply or distribute various software, or the like.

Although the exemplary embodiments have been described above by a limited embodiment and the drawings, various modifications and changes can be made from the above description by those skilled in the art. For example, even when the above-described techniques are performed by different order from the described method and/or components such as systems, structures, devices, or circuits described above are coupled or combined in a different manner from the described method or replaced or substituted with other components or equivalents, the appropriate results can be achieved. It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method for training a co-speech gesture generation model, the method comprising:
receiving, via a data interface, a multimodal input;
masking a subset of the multimodal input;
generating, via an embedder, a multimodal embedding based on the masked multimodal input;
generating, via an encoder, multimodal features based on the multimodal embedding, wherein the encoder includes one or more attention layers connecting different modalities;
generating, via a generator, multimodal output based on the multimodal features;
computing a loss based on the multimodal input and the multimodal output; and
updating parameters of the encoder based on the loss.

2. The method of claim 1, wherein the embedder and the generator are trained by:
receiving, via the data interface, a second multimodal input;
generating, via the embedder, a second multimodal embedding based on the second multimodal input, wherein the second multimodal embedding includes a speech embedding, text embedding, and a pose embedding;
generating, via the generator, a second multimodal output based on the second multimodal embedding;
computing a first embedding loss based on the text embedding and the speech embedding;
computing a second embedding loss based on the text embedding and the pose embedding; and
updating parameters of the embedder and the generator based on the first embedding loss and second embedding loss.

3. The method of claim 2, further comprising:
computing a third embedding loss based on the second multimodal input and the second multimodal output, and wherein updating parameters of the embedder and generator is further based on the third embedding loss.

4. The method of claim 1, wherein the multimodal input includes speech input, text input, and pose input.

5. The method of claim 4, wherein the embedder includes a text embedder, speech embedder, and pose embedder, wherein the text embedder generates a text embedding in the multimodal embedding based on the text input, the speech embedder generates a speech embedding in the multimodal embedding based on the speech input, and the pose embedder generates a pose embedding in the multimodal embedding based on the pose input.

6. The method of claim 4, wherein masking the multimodal input comprises at least one of:
removing all text input based on a first probability;
removing a first subset of the text input based on a second probability;
replacing a second subset of the text input with random words based on a third probability;
removing all speech input based on a fourth probability;
removing a first subset of the speech input based on a fifth probability;
replacing a second subset of the speech input with random speech based on a sixth probability;
removing all pose input based on a seventh probability;
removing a first subset of the pose input based on an eighth probability; or
replacing a second subset of the pose input with random poses based on a ninth probability.

7. The method of claim 1, wherein the generating a multimodal embedding includes first processing an intermediate representation based on the multimodal input.

8. A method for co-speech gesture generation, the method comprising:
receiving, via a data interface, multimodal input;
generating, via an embedder, an embedding based on the multimodal input;
generating, via an encoder, multimodal features based on the embedding;
generating, via a decoder, first motion features based on the multimodal features;
generating, via the decoder, second motion features based on the first motion features and the multimodal features; and
generating, via the generator, a first pose based on the first motion features and a second pose based on the second motion features.

9. The method of claim 8, wherein the multimodal input includes text input, speech input, and pose input and further comprising:
generating, via a generator, reconstructed speech based on speech features and reconstructed text based on text features;
computing a first loss based on reconstructed speech, speech input, reconstructed text, and text input;
computing a second loss based on the first pose, the second pose, and the pose input; and
updating parameters of the embedder, encoder, generator, and decoder based on the first loss and the second loss.

10. The method of claim 8, wherein, wherein the encoder includes one or more attention layers connecting different modalities.

11. The method of claim 9, wherein the decoder includes one or more attention layers, wherein a query associated with one or more attention layers is based on the first pose and a key and value associated with one or more attention layers are based on the multimodal features.

12. The method of claim 8, wherein multimodal input includes text input and speech input.

13. The method of claim 8, wherein the embedder is a neural network comprising at least one fully-connected layer.

14. A system for training a co-speech gesture generation model, the system comprising:
a memory that stores a plurality of processor-executable instructions;
a data interface that receives a multimodal input; and
one or more processors that read and execute the plurality of processor-executable instructions from the memory to perform operations comprising:
masking a subset of the multimodal input;
generating, via an embedder, a multimodal embedding based on the masked multimodal input;
generating, via an encoder, multimodal features based on the multimodal embedding, wherein the encoder includes one or more attention layers connecting different modalities;
generating, via a generator, multimodal output based on the multimodal features;
computing a loss based on the multimodal input and the multimodal output; and
updating parameters of the encoder based on the loss.

15. The system of claim 14, wherein the data interface that receives the multimodal input further receives a second multimodal input and the operations further comprising:
generating, via the embedder, a second multimodal embedding based on the second multimodal input, wherein the second multimodal embedding includes a speech embedding, text embedding, and a pose embedding;
generating, via the generator, a second multimodal output based on the second multimodal embedding;
computing a first embedding loss based on the text embedding and the speech embedding;
computing a second embedding loss based on the text embedding and the pose embedding; and
updating parameters of the embedder and the generator based on the first embedding loss and second embedding loss.

16. The system of claim 15, the operations further comprising:
computing a third embedding loss based on the second multimodal input and the second multimodal output, and wherein updating parameters of the embedder and generator is further based on the third embedding loss.

17. The system of claim 14, wherein the multimodal input includes speech input, text input, and pose input.

18. The system of claim 17, wherein the embedder includes a text embedder, speech embedder, and pose embedder, wherein the text embedder generates a text embedding in the multimodal embedding based on the text input, the speech embedder generates a speech embedding in the multimodal embedding based on the speech input, and the pose embedder generates a pose embedding in the multimodal embedding based on the pose input.

19. The system of claim 17, wherein masking the multimodal input comprises at least one of:
removing all text input based on a first probability;
removing a first subset of the text input based on a second probability;
replacing a second subset of the text input with random words based on a third probability;
removing all speech input based on a fourth probability;
removing a first subset of the speech input based on a fifth probability;
replacing a second subset of the speech input with random speech based on a sixth probability;
removing all pose input based on a seventh probability;
removing a first subset of the pose input based on an eighth probability; or
replacing a second subset of the pose input with random poses based on a ninth probability.

20. The system of claim 14, wherein the generating a multimodal embedding includes first processing an intermediate representation based on the multimodal input.
